(19) United States
(12) Patent Application Publication
(10) Pub. No.: US 2017/0162067 A1
(43) Pub. Date: Jun. 8, 2017

(54) SYSTEM FOR ASSISTING IN MANAGING THE FLIGHT OF AN AIRCRAFT, IN PARTICULAR OF A TRANSPORT AIRPLANE, IN A LANDING PHASE ON A RUNWAY

(71) Applicant: AIRBUS OPERATIONS (S.A.S.), Toulouse (FR)

(72) Inventors: Patrice ROUQUETTE, POMPERTUZAT (FR); Anne DUMOULIN, TOULOUSE (FR); Jean-Claude MERE, VERFEIL (FR)

(21) Appl. No.: 15/360,534

(22) Filed: Nov. 23, 2016

(30) Foreign Application Priority Data
Dec. 4, 2015 (FR) 1561833

(51) Int. Cl. G08G 5/02; B64D 43/02; G05D 1/04; B64D 45/08

(52) U.S. Cl. CPC G08G 5/025; B64D 45/08; B64D 43/02; G05D 1/042

(57) ABSTRACT

A system for assisting in managing the flight of an aircraft in a landing phase. The system comprises a trajectory computation module for determining a trajectory of the aircraft, an interface module and an auxiliary computation module for computing an optimized ground slope, a display unit for allowing an operator to make a selection of the optimized ground slope, and a guidance unit for transmitting guidance orders to controls of the aircraft, the system being configured for the aircraft to follow the optimized ground slope when the latter is selected by the interface module, such that the aircraft reaches a target vertical speed on initiation of the flare phase of the landing.

### CROSS-REFERENCE TO RELATED APPLICATION

This application claims the benefit of and priority to French patent application number 15 61833 filed on Dec. 4, 2015, the entire disclosure of which is incorporated by reference herein.

### TECHNICAL FIELD

The present disclosure relates to a system for assisting in managing the flight of an aircraft, in particular of a transport airplane, in a landing phase on a runway.

### BACKGROUND

It is known that, according to the standard procedural rules, to land, an aircraft (for example a civilian transport airplane) passes from a start-of-descent altitude to a start-of-final approach:
either by performing a descent at constant speed then an approach level defined, for example by an altitude of 3000 feet (i.e. approximately 914 meters), to decelerate then stabilize at a predetermined intermediate speed, the aircraft holding on this level, with this intermediate speed, for example until it intercepts a predefined approach axis;
all by performing a continuous descent approach, according to which the deceleration level at constant altitude is eliminated, such that the aircraft descends and decelerates simultaneously, this step possibly being broken down into several sections each having specific descent slopes.

The interception of the approach level or of the final segment of the approach in continuous descent, and of the approach axis defines the beginning of the final approach phase.

The final approach is, generally, located on an axis defined by beams (of “localizes” and “glide path” type) of an instrument landing system, ILS, which imposes the location of a culmination point, that is to say where the descent axis meets the runway.

New navigation technologies now make it possible to perform satellite-guided approaches. The approaches for which only the lateral guidance is required are qualified as non-precision approach. The approaches for which a lateral and vertical guidance is required are qualified as approach with vertical guidance. The precision approaches, for their part denote the cases where the aircraft is further guided in the vertical plane, by having recourse to precision systems such as the GLS system (“GBAS Landing System” in which GBAS stands for “Ground-Based Augmentation System”).

The FLS (“FMS landing system”) function for example proposes a vertical construction of a fixed approach axis from information published on non-precision approach or vertical guidance approach maps, for example coded in a navigation database of the aircraft, to allow the aircraft to follow a final straight segment according to the non-precision approach axis, as in ILS for example. The FMS system defines this final segment from the following parameters: slope, direction and anchor point (or end point).

Thus, there are so-called precision approaches based on the definition of an approach axis originating from devices external to the aircraft (GLS, ILS or MLS for example), so-called non-precision approaches and so-called approaches with vertical guidance which are based on an approach axis defined by a system of the aircraft (FLS) or which are not based on an approach axis (instrument guidance).

It is also known that, to avoid obstacles (for example formed by the relief, the buildings, etc.), an approach phase with increased ground slope (that is to say that there is a switch, for example, from a standard ground slope of −3° to a ground slope of) −4°) can be performed.

Increasing the ground slope (and therefore the vertical ground speed) involves revising the maneuverability and deceleration capabilities, even redimensioning the landing gears, culminating in an additional onboard load, in significant modifications to the systems of the aircraft, and in the need for suitable training of the pilots.

To at least partly remedy this drawback, there is known, from the patent application FR 2 972 541, a landing optimization method. This method serves to optimize the landing of an aircraft on a runway, the landing comprising an approach phase defined by an approach axis to be followed with which is associated a predefined ground slope and a flare phase. The method determines an optimized ground slope (relative to the ground slope deriving from the standard procedure rules) from a predefined target vertical speed using characteristics specific to the aircraft and one or more external parameters.

However, this method is difficult to implement onboard an aircraft, and necessitates a particular implementation to be able to be used in accordance with the usual navigation devices onboard an aircraft. Furthermore, the method of the patent application FR 2 972 541 is limited to an approach in which an approach axis with co-ordinates that are often received from an external device is used.

### SUMMARY

An object of the present disclosure is to remedy this drawback and to provide a system making it possible to implement an optimization method of the abovementioned type, and to do so regardless of the type of the approach procedure of the aircraft in a landing, whether precision or non-precision, with or without approach axis.

To this end, according to the disclosure herein, a system for assisting in managing the flight of an aircraft in a landing phase on a runway, the landing phase comprising an approach phase, which can be of the so-called precision type, of the so-called type with vertical guidance or of the so-called non-precision type, and a flare phase, is noteworthy in that it comprises:
a flight management system, comprising a trajectory computation module configured to determine a trajectory of the aircraft, an interface module, and an auxiliary computation module configured to compute an optimized ground slope as a function of a target vertical speed relative to the ground to be applied to the aircraft on initiation of the flare phase and of at least one external parameter;
a display unit linked to the interface module and configured to display information, and to allow on operator to make a selection of the optimized ground slope; and
a guidance unit configured to transmit guidance orders to controls of the aircraft.

Furthermore, according to the disclosure herein, the system is configured for the aircraft to follow the optimized ground slope when the latter is selected by the interface module, such that the aircraft reaches the target vertical speed previously defined on initiation of the flare phase.

Thus, by virtue of the disclosure herein, not only does the system make it possible to implement the optimization of the ground slope of the approach axis with modified standard navigation devices, but also, this optimization can be implemented for any type of approach, whether precision or non-precision, with or without approach axis.

In effect, the flight management system further comprises an auxiliary computation module for computing the optimized ground slope and an interface module. The auxiliary computation module interacts, on the one hand, with the display unit to present the optimized ground slope to the crew so that it can be selected, and, on the other hand with the trajectory computation module such that it computes a trajectory of the aircraft corresponding to the optimized ground slope.

This system architecture is thus suited to any type of approach, whether precision or non-precision.

Preferably, the system further comprises a signal reception unit of multimode type, linked to the flight management system and to the guidance unit, the reception unit being configured to compute deviations of position of the aircraft relative to the optimized ground slope and to transmit the position deviations to the guidance unit, the guidance unit being configured to determine guidance orders as a function of the position deviations of the aircraft, such that the system guides the aircraft according to the optimized ground slope.

Preferably, to manage a precision approach, for which the approach phase is defined by an approach axis with which is associated a predefined ground slope, the reception unit is configured to receive an external signal indicating, either the predefined ground slope for it to compute the angular difference between the position of the aircraft and the predefined ground slope, or, directly, the angular difference between the position of the aircraft and the predefined ground slope, and the trajectory computation module is configured to compute the deviation between the optimized ground slope and the predefined ground slope, and to transmit the predefined ground slope and the deviation to the reception unit.

Furthermore, as soon as the reception unit receives, or computes, the angular difference between the position of the aircraft and the predefined ground slope, it modifies this difference as a function of the deviation between the optimized ground slope and the predefined ground slope to compute the position deviation of the aircraft relative to the predefined ground slope.

Moreover, to manage a non-precision approach for which the approach phase is defined by an approach axis of the flight management system, the trajectory computation module is configured to transmit, directly to the reception unit, the optimized ground slope with a deviation of zero value relative to the predefined slope, the reception unit being configured to receive from the flight management system the position of the aircraft so as to compute the position deviations between the aircraft and the optimized ground slope.

Moreover, to manage a non-precision approach or an approach with vertical guidance without approach axis, the flight management system further comprises:
an approach module configured to compute a vertical deviation of the aircraft; and
a guidance module configured to compute guidance orders and transmit them directly to the guidance unit.

Furthermore, the flight management system is configured to define the target vertical speed from performance and characteristics specific to the aircraft.

Preferably, the external parameter or parameters belong to the group of parameters comprising:
the corrected airspeed CAS of the aircraft. This speed CAS is a function of the weight of the aircraft and of the flight configuration of the aircraft associated with the approach phase, such that, by involving the CAS speed in the determination of the optimized slope, the latter two parameters (weight M, fight configuration) are taken into account;
the outside temperature at a standard height;
the horizontal windspeed;
the inclination of the runway relative to the horizontal; and
the altitude of the runway.

Furthermore:
the flight management system further comprises:
   an element for computing the air density at the standard height, as a function of the outside temperature and of the altitude of the runway; and
   an element for computing the true airspeed of the aircraft, from the computed speed and air density; and
the auxiliary computation module is configured to compute the optimized ground slope, from the target vertical speed, the true speed, the horizontal windspeed and the inclination of the runway.

The present disclosure further relates to an aircraft, in particular a transport airplane, comprising a flight management system as mentioned above.

### BRIEF DESCRIPTION OF THE FIGURES

The attached figures will give a good understanding of how the disclosure herein can be produced. In these figures, identical references denote similar elements. More particularly:

FIG. 1 is a block diagram of a first embodiment of a flight management system according to the disclosure herein for managing a precision approach or a non-precision approach or an approach with a vertical guidance approach axis;

FIG. 2 is a block diagram of a second embodiment of a flight management system according to the disclosure herein for managing a so-called non-precision approach, without approach axis; and

FIG. 3 is a diagram illustrating the approach phase of an aircraft implemented by the system according to the first embodiment of the disclosure herein.

### DETAILED DESCRIPTION

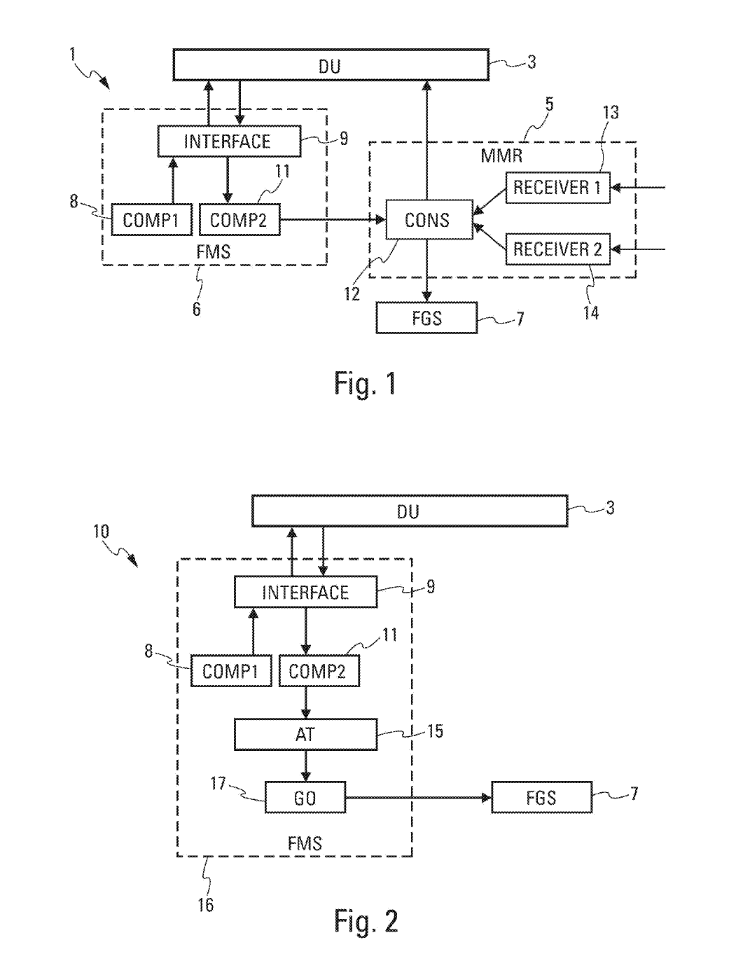

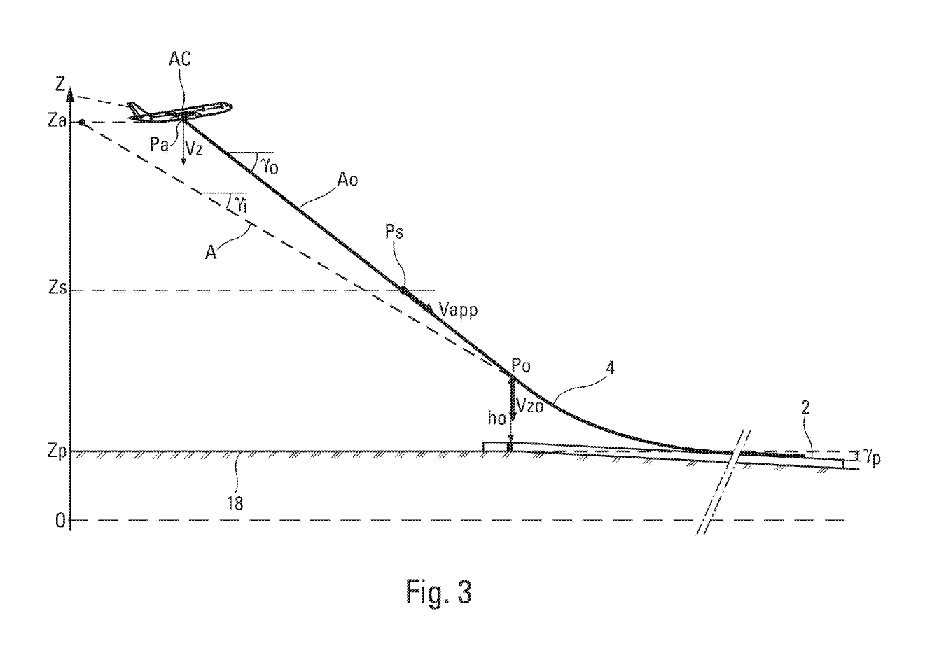

For all the embodiments, the disclosure herein relates to a system 1, 10 (FIGS. 1 and 2) for assisting in managing the flight of an aircraft AC in a landing phase on a runway 2 of an airport, the landing phase comprising an approach phase and a flare phase 4 (FIG. 3).

FIG. 1 illustrates a first embodiment of a system 1 for assisting in managing the flight, onboard the aircraft AC and configured to be used in an approach using an approach axis, where the so-called precision, non-precision or with vertical guidance, the approach phase being defined by an approach axis A to be followed with which is associated a predefined ground slope γ, as represented in FIG. 3.

The system 1 comprises, as represented in FIG. 1:
a flight management system 6 (“FMS”);
a display unit 3 (“DU”);
a flight guidance system 7 (“FGS”); and
a signal reception unit 5, of multimode type (“MMR”, for “muti-mode receiver”).

The flight management system 6 is linked to the display unit 3 and to the reception unit 5. The flight management system 6 notably comprises:
a trajectory computation module 11 (“COMP2”, for “computation unit”) configured to define (and compute) a trajectory of the aircraft;
a user interface module 9 (“INTERFACE”); and
an auxiliary computation module 8 (“COMP1”, for “computation unit”) configured to compute an optimized ground slope γₒ, as a function of a target vertical ground speed Vzo to be applied to the aircraft on initiation of the flare phase 4 and of at least one external parameter.

The flight management system 6 receives, from sensors and/or data management elements which are not represented in the figures, the outside temperature To at a standard height ho, the inclination γₚ and the altitude Zp of the runway 2, the corrected airspeed CAS of the aircraft AC, the target vertical speed Vzo and the horizontal windspeed Vw.

The flight management system 6 further comprises the following integrated elements (not represented specifically in the figures):
a first element for computing, in the usual manner the air density ρ_{c}, at the standard height ho. It receives the outside temperature To and the altitude of the runway Zp. The first element is capable of delivering, as output, the air density ρ_{c} at the height ho ; and
a second element for computing, in the usual manner, the true airspeed TAS of the aircraft AC. For that, it receives the air density ρ_{c}, determined by the first element, and the corrected airspeed CAS. The second element is capable of delivering, as output, the true airspeed TAS that it transmits to the auxiliary computation module 8.

The auxiliary computation module 8 of the flight management system 6 receives the true airspeed TAS, the target vertical speed Vzo, the horizontal windspeed Vw, and the inclination γₚ of the runway 2. The auxiliary computation module 8 is capable of delivering, as output, the optimized ground slope, γₒ, that it transmits to the interface module 9.

The display unit 3 is linked to the interface module 9, and it is configured to display information, in particular the optimized ground slope γₒ, and it is also formed to allow an operator to make the selection of this optimized ground slope γₒ. The optimized ground slope γₒ is transmitted by the auxiliary computation module 8 to the interface module 9, which displays it on the display unit 3. The optimized ground slope γₒ can be selected for example by a standard selection device (keyboard, trackball, etc.) of the interface module 9.

If the optimized ground slope γₒ is selected, it is transmitted to the trajectory computation module 11 which computes the trajectory deviation of the optimized slope γₒ relative to a predefined slope γᵢ. The trajectory computation module 11 transmits the predefined slope γᵢ and the trajectory deviation to the reception unit 5.

The reception unit 5 is provided with a consolidation element 12 (“CONS”) linked to the trajectory computation module 11 and to the guidance unit 7. The reception unit 5 is configured to receive an external signal by two signal receivers 13 and 14 (receiver 1 and receiver 2), which are linked to the consolidation element 12. The external signal indicates, either the predefined ground slope γᵢ, for the reception unit 5 to compute itself the angular difference between the position of the aircraft AC and the predefined ground slope γᵢ (with a GLS system for example) or, directly, the angular difference between the position of the aircraft AC and the predefined ground slope (with an ILS system for example). The consolidation element 12 is configured to compute deviations of the vertical position of the aircraft AC relative to the optimized slope γₒ, and to transmit these deviations to the guidance unit 7.

Thus, when the optimized ground slope γₒ is selected, and as soon as the reception unit 5 receives, or computes, the angular difference between the position of the aircraft and the predefined ground slope γᵢ, the consolidation element 12 modifies this difference as a function of the deviation between the optimized ground slope γₒ and the predefined ground slope γᵢ to compute the vertical position deviations between the position of the aircraft AC and the predefined slope γᵢ. Thus, the consolidation element 12 adds the deviation of the optimized ground slope γₒ relative to the predefined slope γᵢ to the angular difference between the position of the aircraft AC and the predefined ground slope γᵢ. The vertical deviation of the aircraft AC is then transmitted to the guidance unit 7 in order to guide the aircraft AC according to the optimized ground slope γₒ (along an axis Ao), for it to reach the target vertical speed Vzo previously defined on initiation of the flare phase 4, as represented in FIG. 3.

The guidance unit 7 is configured to receive vertical deviations of the aircraft AC, to determine guidance orders as a function of the vertical deviations for the aircraft AC to follow the trajectory of the optimized ground slope γₒ, and to transmit the guidance orders to the usual controls (namely actuation elements of controlled members) of the aircraft AC.

To this end, the guidance unit 7 comprises the following elements (not specifically represented in the figures):
a computation element which is intended to determine, in the usual manner, piloting set-points from the deviations received from the reception unit 5;
at least one piloting assistance element, for example an automatic piloting device and/or a flight director, which determines, from the piloting set-points received from the computation element, piloting orders for the aircraft AC; and
an actuation element of controlled members, such as, for example, controlled surfaces (rudder, elevator, etc.) of the aircraft, to which the duly determined piloting orders are applied.

In the situation represented schematically in FIG. 3 (which notably illustrates altitude Z of an aircraft AC is a function of its horizontal distance relative to a runway 2), the aircraft AC (having a vertical speed Vz) is in approach phase with a view to landing on the runway 2 situated at an altitude Zp. After a flight on an approach level of altitude Za or after an intermediate continuous descent approach, the aircraft AC intercepts a final approach axis Ao, having an optimized ground slope γₒ, at a point Pa (which corresponds to the intersection of the level Za, or of the segment of the continuous descent approach, and of the approach axis Ao) and descends along the axis Ao toward the runway 2 to decelerate to the stabilized approach speed Vapp at a stabilization altitude Zs at approximately 1000 feet (point Ps), to then reach the target constant vertical speed Vzo relative to the ground 18 at a point Po. The latter marks the start of the flare 4 which follows the approach phase.

In a second embodiment of a system for assisting in flight management, configured to be used in a non-precision approach or an approach with vertical guidance of FLS type, the system (not specifically represented) is similar to that of the first embodiment of FIG. 1. Nevertheless, the first difference lies in the fact that the reception unit 5 does not receive any approach axis from instruments outside the aircraft but it receives an approach axis from the flight management system, for example computed by an additional computation module, or which is stored in a database. The auxiliary computation module 8 computes the optimized ground slope γₒ from this approach axis computed by the auxiliary computation module. In this embodiment, when the optimized ground slope γₒ is selected by the crew by the interface module 3, the trajectory computation module 11 transmits, directly to the reception unit 5, the optimized ground slope γₒ with a deviation of zero value relative to the predefined slope γᵢ. The reception unit 5 also receives, from the flight management system 6, 16 the position of the aircraft AC. Thus, the reception unit 5 computes the vertical deviation between the position of the aircraft AC and the optimized ground slope γₒ, without adding any additional deviation. The vertical deviation is automatically transmitted to the guidance unit 7 in order for it to guide the aircraft AC according to the optimized ground slope γₒ, for it to reach the target vertical speed previously defined on initiation of the flare phase.

A third embodiment of a system for assisting in flight management, configured to be used in a so-called non-precision approach without approach axis, is represented in FIG. 2. Like the system 1 of the preceding embodiments, the system 10 for assisting in flight management of FIG. 2 comprises:
a flight management system 16;
a display unit 3; and
a guidance unit 7.

In this embodiment, the system 10 does not comprise any reception unit of MMR type. On the other hand, the flight management system 16 comprises, in addition:
an approach trajectory computation module (or approach module) 15 (AT, for “Approach Trajectory”); and
a guidance order computation module (or guidance module) 17 (GO, for “Guidance Orders”).

The approach module 15 is linked to the trajectory computation module 11 in order to be able to compute the vertical deviations of the aircraft

AC relative to the optimized ground slope γₒ received, when it is selected using the interface module 9. The approach module 15 then transmits the deviations to the guidance module 17, which computes guidance orders. These guidance orders are then transmitted to the guidance unit 7.

Thus, the aircraft AC is guided according to the optimized ground slope γₒ, for it to reach the target vertical speed Vzo on initiation of the flare phase 4. The operation of this system 10 differs (from that of the system 1) in that it does not detect an approach axis, and in that the flight management system 16 itself computes the guidance orders as a function of the optimized ground slope γₒ.

In a fourth embodiment, not represented in the figures, the system for assisting in flight management (called global) combines on the one hand, the system common to the first and second embodiments for an approach phase with approach axis, and, on the other hand, the system of the third embodiment without approach axis. Thus, this global system comprises a reception unit configured to operate according to the first and second embodiments, and a single flight management system configured to operate to all of the embodiments. The flight management system therefore comprises an approach module and a guidance module, in addition to the trajectory computation, interface and auxiliary computation modules. The global system is thus configured to implement the guidance according to an optimized ground slope for any type of approach by following the respective steps of the methods corresponding to each approach.

When the approach phase is a precision or non-precision phase or a phase with vertical guidance with an approach axis, the global system for assisting in flight management uses the reception unit in the manner corresponding to the first and second embodiments to determine the guidance orders, without using the approach module and the guidance module.

Furthermore, when the approach phase is a non-precision phase without approach axis, the global system for assisting in flight management uses the approach module and the guidance module, without having recourse to the reception unit.

The global system for assisting in flight management comprises automatic adaptation for the following optimized slope method to correspond to the type of approach chosen when the optimized ground slope is selected. Thus, it is sufficient for the crew to choose the type of approach for the landing phase. In the case of subsequent selection of the optimized ground slope, the global system uses the units, elements and/or modules of the system for assisting in flight management corresponding to the type of approach phase considered.

The subject matter disclosed herein can be implemented in and with software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the present invention(s) has been shown and described, it should be understood that modifications, substitutions and alternatives may be apparent to one of ordinary skill in the art and can be made without departing from the scope of the disclosure described herein. This application is intended to cover any adaptations or variations of the specific embodiments discussed herein. In addition, in this disclosure, the terms “comprise” or “comprising” do not exclude other elements or steps, and the terms “a”, “an” or “one” do not exclude a plural number. Furthermore, characteristics or steps which have been described with reference to one of the above exemplary embodiments may also be used in combination with other characteristics or steps of other exemplary embodiments described above.

1. A system for assisting in managing a flight of an aircraft in a landing phase on a runway, the landing phase comprising an approach phase that is a precision type with vertical guidance or is a non-precision type, and a flare phase,
the system comprising:
a flight management system comprising a trajectory computation module configured to determine trajectory of the aircraft, an interface module, and an auxiliary computation module configured to compute an optimized ground slope as a function of a target vertical speed relative to ground to be applied to the aircraft on initiation of the flare phase and of at least one external parameter;
a display unit linked to the interface module and configured to display information, and to allow an operator to make a selection of the optimized ground slope; and
a guidance unit configured to transmit guidance orders to controls of the aircraft;
the system being configured for the aircraft to follow the optimized ground slope when the optimized ground slope is selected by the interface module, such that the aircraft reaches the target vertical speed previously defined on initiation of the flare phase.

2. The system as claimed in claim 1,
comprising a signal reception unit of multimode type, linked to the flight management system and to the guidance unit, the reception unit being configured to compute deviations of position of the aircraft relative to the optimized ground slope, and to transmit the position deviations to the guidance unit, the guidance unit being configured to determine guidance orders as a function of the position deviations of the aircraft, such that the system guides the aircraft according to the optimized ground slope.

3. The system as claimed in claim 2,
wherein, to manage a precision approach, for which the approach phase is defined by an approach axis with which is associated a predefined ground slope, the reception unit is configured to receive an external signal indicating, either the predefined ground slope for it to compute an angular difference between the position of the aircraft and the predefined ground slope, or, directly, the angular difference between the position of the aircraft and the predefined ground slope, and the trajectory computation module is configured to compute deviation between the optimized ground slope, and the predefined ground slope, and to transmit the predefined ground slope, and the deviation to the reception unit.

4. The system as claimed in claim 3,
wherein, as soon as the reception unit receives, or computes the angular difference between the position of the aircraft and the predefined ground slope, the reception unit modifies the difference as a function of the deviation between the optimized ground slope and the predefined ground slope to compute position deviations of the aircraft relative to the predefined ground slope.

5. The system as claimed in claim 2,
wherein, to manage a non-precision approach or an approach with vertical guidance, for which the approach phase is defined by an approach axis of the flight management system, the trajectory computation module is configured to transmit, directly to the reception unit the optimized ground slope with a deviation of zero value relative to the predefined slope, the reception unit being configured to receive from the flight management system the position of the aircraft so as to compute position deviations between the aircraft and the optimized ground slope.

6. The system as claimed in claim 1, wherein to manage a non-precision approach or an approach with vertical guidance without approach axis, the flight management system further comprises:
an approach module configured to compute a vertical deviation of the aircraft; and
a guidance module configured to compute guidance orders and transmit them directly to the guidance unit.

7. The system as claimed in claim 1, wherein the flight management system is configured to define the target vertical speed from performance and characteristics specific to the aircraft.

8. The system as claimed in claim 1,
wherein the external parameter is selected from a group of parameters comprising:
corrected airspeed of the aircraft;
outside temperature at a standard height;
horizontal windspeed;
inclination of the runway relative to horizontal; and
altitude of the runway.

9. The system as claimed in claim 8, wherein the flight management system further comprises:
an element for computing air density at standard height, as a function of outside temperature and of altitude of the runway; and
an element for computing true airspeed of the aircraft, from the computed speed and air density; and
wherein the auxiliary computation module is configured to compute the optimized ground slope, from the target vertical speed, the true speed, the horizontal windspeed and the inclination of the runway.

10. An aircraft, comprising a system for assisting in management of the flight, the system for assisting in managing a flight of an aircraft in a landing phase on a runway, the landing phase comprising an approach phase that is a precision type with vertical guidance or is a non-precision type, and a flare phase,
the system comprising:
a flight management system comprising a trajectory computation module configured to determine trajectory of the aircraft, an interface module, and an auxiliary computation module configured to compute an optimized ground slope as a function of a target vertical speed relative to ground to be applied to the aircraft on initiation of the flare phase and of at least one external parameter;
a display unit linked to the interface module and configured to display information, and to allow an operator to make a selection of the optimized ground slope; and
a guidance unit configured to transmit guidance orders to controls of the aircraft;
the system being configured for the aircraft to follow the optimized ground slope when the optimized ground slope is selected by the interface module, such that the aircraft reaches the target vertical speed previously defined on initiation of the flare phase.
